(19) United States
(12) Patent Application Publication
(10) Pub. No.: US 2013/0052439 A1
(43) Pub. Date: Feb. 28, 2013

(54) MAGNETIC SUBSTRATE AND METHOD FOR MANUFACTURING THE SAME

(71) Applicants: Yong Suk KIM, Gyeonggi-do (KR); Kang Heon HUR, Gyeonggi-do (KR); Sang Moon LEE, Seoul (KR); Young Seuck YOO, Seoul (KR); Jeong Bok KWAK, Gyeonggi-do (KR); Sung Kwon WI, Seoul (KR)

(72) Inventors: Yong Suk KIM, Gyeonggi-do (KR); Kang Heon HUR, Gyeonggi-do (KR); Sang Moon LEE, Seoul (KR); Young Seuck YOO, Seoul (KR); Jeong Bok KWAK, Gyeonggi-do (KR); Sung Kwon WI, Seoul (KR)

(73) Assignee: Samsung Electro-Mechanics Co., Ltd., Suwon (KR)

(21) Appl. No.: 13/568,760

(22) Filed: Aug. 7, 2012

(30) Foreign Application Priority Data
Aug. 31, 2011 (KR) 10-2011-0087992

(51) Int. Cl. B32B 7/02

(52) U.S. Cl. 428/215; 428/213

(57) ABSTRACT

The present invention provides a magnetic substrate, which comprises a first magnetic layer made of a first magnetic material; and a second magnetic layer made of a second magnetic material, wherein the first and second magnetic materials are equal each other, and have different grain sizes.

### CROSS-REFERENCE TO RELATED APPLICATIONS

This application claims the benefit under 35 U.S.C. Section 119 of Korean Patent Application Serial No. 10-2011-0087992, filed Aug. 31, 2011, which is hereby incorporated by reference in its entirety into this application.

### BACKGROUND OF THE INVENTION

1. Field of the Invention

The present disclosure relates to a magnetic substrate and a method for manufacturing the same.

2. Description of the Related Art

In recent years, it is often the case that electronic devices such as a digital TV, a smart phone, and a laptop computer transmit and receive data at a high frequency band. Such electronic devices are connected to various communication tools such as Universal Serial Bus (USB), Bluetooth (registered trademark), ZigBee or the like so that they include a multi-functionality and a hybrid functionality, which will be expected to increase a high frequency of use.

On the other hand, in the conventional communication scheme, frequency band signals on the order of MHz is gradually changed into high frequency band signals (e.g., GHz) so as to enhance a transmission/reception rate.

Unfortunately, when the high frequency signals on the order of several tens or hundreds of GHz are communicated between devices, a problem is posed in that it is difficult to faithfully process data due to a signal delay, a transmission/reception distortion or the like.

Particularly, in case of a digital television set, various problems such as the signal delay, the transmission/reception distortion or the like, which are described above, may be frequently posed in a variety of port-to-port connections between video and audio signal terminals.

A noise reduction device (EMI countermeasure parts) is provided to solve such problems. Such conventional EMI countermeasure parts, which are implemented by, e.g., a winding type, a stack type and the like, have a large size and a relatively low level of electrical properties. This configuration allows the parts to be used only in a limited area such as few circuit boards.

In order to solve the problems associated with the aforementioned winding and stack type of common mode filters, and also to meet the demand for small in size and miniaturization of electronic devices, a number of studies are under way on a thin-film common mode filter.

The thin-film common mode filter is manufactured by forming an insulating layer on a magnetic substrate formed by sintering a magnetic substance such as Ferrite, and then forming a conductive pattern on the magnetic substrate.

Unfortunately, a difference in shrinkage factor that is caused in sintering the conventional magnetic substrate causes a distortion in the substrate. The reason for this is that a magnetic material to be used in forming a magnetic layer irregularly growths in horizontal, vertical, and thickness directions during the sintering process.

For example, the thickness of the magnetic substrate is varied at the central and outer portions thereof to thereby cause a deflection (or distortion), which is prone to cause a crack even with a small shock. This causes a reduced reliability.

In addition, a difference in sintering density of the magnetic substrate made of the magnetic substance may be caused. Such difference allows chemicals to be used in, e.g., a photolithography process to flow to the inside of the magnetic substrate, which causes voids or erosion therein.

In addition, even if the conductive pattern is formed on the magnetic substrate, as shown in FIGS. 1A to 1C, an outer pattern may be collapsed (FIG. 1A), a separation between the conductive pattern and the magnetic substrate (FIG. 1B) may be occurred, or the shape of the upper surface of the conductive pattern may be changed (FIG. 1C).

This causes a decreased coupling coefficient of the common mode filter and a reduced reliability.

On the other hand, in Japanese Patent Laid-Open Publication No. 2004-22798, which is proposed to solve these problems, an approach is disclosed dipping a magnetic ceramic element made of a magnetic substance within plating solution, and then injecting the plating solution therein starting from a portion where an internal conductive layer is exposed to the surface of a magnetic ceramic element, so that voids are formed between the magnetic ceramic layer and the internal conductive layer. Unfortunately, a low efficiency in manufacturing the substrate made of the magnetic substance fails to commercialize in market.

### SUMMARY OF THE INVENTION

The present invention has been invented in order to overcome the above-described problems and it is, therefore, an object of the present invention to provide a magnetic substrate and a method for manufacturing the same in which a distortion is minimized in a sintering process.

In accordance with one aspect of the present invention to achieve the object, there is provided a magnetic substrate, which comprises a first magnetic layer made of a first magnetic material; and a second magnetic layer made of a second magnetic material, wherein the first and second magnetic materials are equal each other, and have different grain sizes.

In one embodiment, the grain size of the second magnetic material is set to fall within the range of 6 to 50 times that of the first magnetic material.

In one embodiment, the grain size of the first magnetic layer is set to fall within the range of 1 to 5 μm, and the grain size of the second magnetic layer is set to fall within the range of 30 to 50 μm.

In one embodiment, the second magnetic layer is formed on the upper and bottom surfaces of the first magnetic layer, respectively.

In one embodiment, the thickness of the first magnetic layer is set to 2.5 to 14 times that of the second magnetic layer.

In one embodiment, the thickness of the first magnetic layer is set to fall within the range of 500 to 700 μm, and the thickness of the second magnetic layer is set to fall within the range of 50 to 200 μm.

In one embodiment, the second magnetic layer is further formed on a side surface of the first magnetic layer.

In one embodiment, the second magnetic layer is formed on respective corner of the upper and bottom surfaces of the first magnetic layer

In one embodiment, the thickness of the first magnetic layer is set to fall within the range of 2 to 7 times that of the second magnetic layer.

In one embodiment, the thickness of the first magnetic layer is set to fall within the ranges of 400 to 700 μm, and the thickness of the second magnetic layer is set to fall within the ranges of 100 to 200 μm.

In one embodiment, the length of the first magnetic layer is 3.2 to 6.7 times that of the second magnetic layer.

In one embodiment, the length of the first magnetic layer is set to fall within the range of 8 to 12 mm, and the length of the second magnetic layer is set to fall within the range of 1.8 to 2.5 mm.

In one embodiment, the second magnetic layer is further formed on a side surface of the first magnetic layer.

In one embodiment, the second magnetic layer is formed on the upper and bottom surfaces of the first magnetic layer, respectively, and at least one of the second magnetic layers are formed inside of the first magnetic layer.

In one embodiment, the thickness of the second magnetic layer is set to fall within the range of 50 to 200 μm.

In one embodiment, the second magnetic layer is further formed on a side surface of the first magnetic layer.

In accordance with another aspect of the present invention to achieve the object, there is provided a method of manufacturing a magnetic substrate, which comprises: (a) coating a second magnetic material on the upper surface of a base substrate; (b) coating a first magnetic material on the upper surface of the second magnetic material; (c) coating the second magnetic material on the upper surface of the first magnetic material; and (d) after the step (c), sintering the first and second magnetic materials, wherein the first and second magnetic materials have different grain sizes.

In one embodiment, the grain size of the first magnetic material is set to fall within the range of 1 to 5 μm, and the grain size of the second magnetic material is set to fall within the range of 30 to 50 μm.

In one embodiment, the step (d) is performed at a pressure having the range of 10 to 50 MPa.

In one embodiment, the step (d) is performed at a temperature having the range of 600 to 900 degrees Celsius.

In another embodiment, the step (d) is performed at a temperature ranging from 600 to 900 degrees Celsius for 2 to 3 hours.

In another embodiment, the process is fed back to the step (b) after the step (c), wherein the steps (b) and (c) are further performed at least one time.

In accordance with still another aspect of the present invention to achieve the object, there is provided a method of manufacturing a magnetic substrate, which comprises: (a) coating a second magnetic material on left and right regions of the upper surface of a base substrate; (b) coating a first magnetic material on the upper surfaces of the second magnetic material and the base substrate; (c) coating the second magnetic material on left and right regions of the upper surface of the first magnetic material; and (d) after the step (c), sintering the first and second magnetic materials, wherein the first and second magnetic materials have different grain sizes.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1A shows a schematic cross-sectional view illustrating one example of a poor conductive pattern which is caused due to a difference in shrinkage factor of a magnetic substrate according to the conventional technology.

FIG. 1B shows a schematic cross-sectional view illustrating another example of a poor conductive pattern which is caused due to a difference in shrinkage factor of a magnetic substrate according to the conventional technology.

FIG. 1C shows a schematic cross-sectional view illustrating another example of a poor conductive pattern which is caused due to a difference in shrinkage factor of a magnetic substrate according to the conventional technology.

FIGS. 2 to 7 show a schematic cross-sectional view of a magnetic substrate according to the present disclosure, respectively.

FIGS. 8A to 8D show schematic cross-sectional views illustrating a method of manufacturing the magnetic substrate according to the present disclosure.

FIGS. 9A to 9E show schematic cross-sectional views illustrating a method of manufacturing the magnetic substrate according to the present disclosure.

FIG. 10A is a photograph showing a fine structure of a conventional magnetic substrate.

FIG. 10B is a photograph showing a fine structure of a magnetic substrate according to the present disclosure.

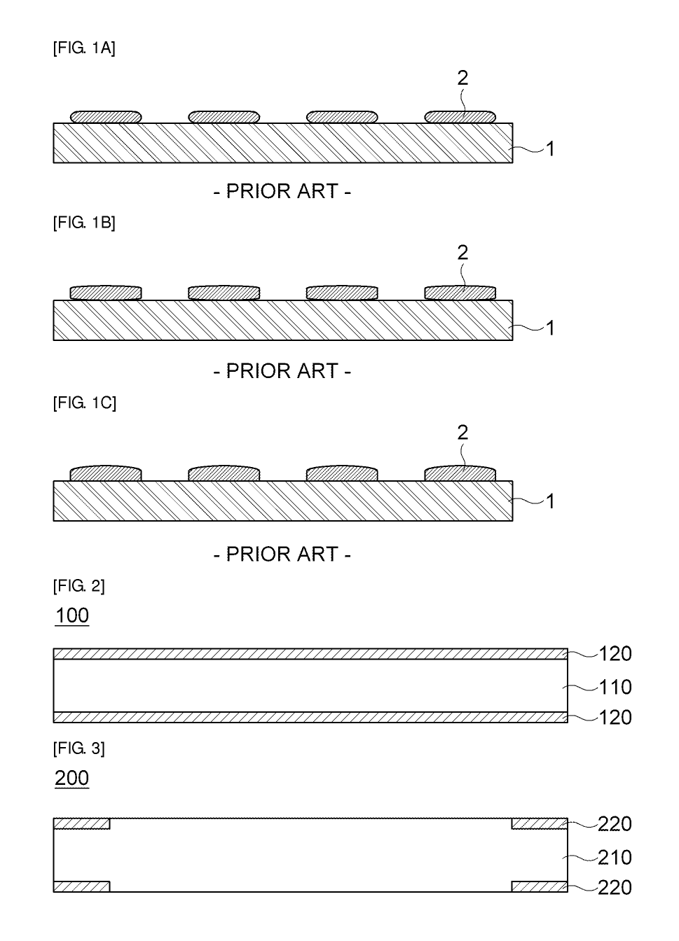

### DETAILED DESCRIPTION OF THE PREFERABLE EMBODIMENTS

Hereinafter, specific embodiments of the present invention will be described with reference to the accompanying drawings. However, the following embodiments are provided as examples but are not intended to limit the present invention thereto.

Descriptions of well-known components and processing techniques are omitted so as not to unnecessarily obscure the embodiments of the present invention. The following terms are defined in consideration of functions of the present invention and may be changed according to users or operator's intentions or customs. Thus, the terms shall be defined based on the contents described throughout the specification.

The technical sprit of the present invention should be defined by the appended claims, and the following embodiments are merely examples for efficiently describing the technical spirit of the present invention to those skilled in the art.

A magnetic substrate according to one embodiment of the present disclosure includes a first magnetic layer made of a first magnetic material and a second magnetic layer made of a second magnetic material, where the first and second materials have different grain sizes and the same type.

In general, a grain growth is rapidly progressed with a smaller grain size, while it is slowly progressed with a larger grain size. In other words, the speed of the grain growth is inversely proportional to the grain size.

It is appreciated that the reason for this is that a specific surface area of a corresponding material is increased with a smaller grain size, thereby increasing a sintering driving force.

By considering the aforementioned principle, the first magnetic layer made of a first magnetic material having a relatively small grain size may be quickly sintered compared to the second magnetic layer. As such, differences in thickness and length, which are caused by the difference in shrinkage factor during the sintering process for the first magnetic layer, may be decreased during the sintering process on the second magnetic layer.

Preferably, the grain size of the second magnetic layer is set to fall within the range of 6 to 50 times that of the first magnetic layer.

Specifically, the grain size of the first magnetic layer may fall within the range of 1 to 5 μm, and the grain size of the second magnetic layer may fall within the range of 30 to 50 μm.

If the grain size of the first magnetic layer is smaller than 1 μm, it may cause voids, and if the grain size of the first magnetic layer is larger than 5 μm, a compact cluster may be generated between the grains. This causes a reduced local intensity.

If the grain size of the second magnetic layer is smaller than 30 μm, it is difficult to buffer a distortion to be caused by a difference in shrinkage factor of the first magnetic layer. And, if the grain size of the second magnetic layer is larger than 50 μm, it causes a decreased bonding force between the first and second magnetic layers, to thereby occur problems such as a phase separation, voids or the like. Further, a layer isolation, i.e., delamination, which is generated after the sintering process, may be generated.

FIGS. 2 to 7 show a schematic cross-sectional view of a magnetic substrate according to the present disclosure, respectively.

As shown in FIG. 2, a magnetic substrate 100 according to a first embodiment of the present disclosure includes a first magnetic layer 110 and a second magnetic layer 120 which is respectively formed on the upper and bottom surfaces of the first magnetic layer 110.

The thickness of the first magnetic layer 110 may be 2.5 to 14 times that of the second magnetic layer 120.

Specifically, the thickness of the first magnetic layer 110 may be set to fall within the range of 500 to 700 μm, and the thickness of the second magnetic layer 120 may be set to fall within the range of 50 to 200 μm.

If the thickness of the second magnetic layer 120 is too thicker than that of the first magnetic layer 110, it results in an increased grain growth, thereby generating voids and deteriorating a sintering density.

Meanwhile, if the thickness of the second magnetic layer 120 is too thinner than that of the first magnetic layer 110, it is difficult to avoid a distortion to be caused by the difference in shrinkage factor of the first magnetic layer 110.

With this configuration, the second magnetic layer 120 is configured to absorb a variation in thickness of the magnetic substrate 100, which results from the difference in shrinkage factor of the first magnetic layer 110 during the sintering process.

Referring to FIG. 3, a magnetic substrate 200 in accordance with a second embodiment of the present disclosure includes a first magnetic layer 210 and a second magnetic layer 220 formed on respective corner of the upper and bottom surfaces of the first magnetic layer 210.

The thickness of the first magnetic layer 210 may be set to fall within the range of 2 to 7 times that of the second magnetic layer 220. And, the length of the first magnetic layer 210 may be set to fall within the range of 3.2 to 6.7 times that of the second magnetic layer 220.

Specifically, the thickness and length of the first magnetic layer 210 may be set to fall within the ranges of 400 to 700 μm, and 8 to 12 mm, respectively. The thickness and length of the second magnetic layer 220 may be set to fall within the ranges of 100 to 200 μm, and 1.8 to 2.5 mm, respectively.

If the thickness of the second magnetic layer 220 is too thicker than that of the first magnetic layer 210, it results in an increased grain growth, thereby generating voids and deteriorating a sintering density.

Meanwhile, if the thickness of the second magnetic layer 220 is too thinner than that of the first magnetic layer 210, it fails to prevent a distortion to be caused by the difference in shrinkage factor of the first magnetic layer 210.

In addition, if the length of the first magnetic layer 210 is too long compared to that of the second magnetic layer 220, the phase separation occurs, so that a crack or delamination may be generated.

In contrast, the length of the second magnetic layer 220 is too short compared to that of the first magnetic layer 210, it is difficult to stably buffer a distortion to be caused by the difference in shrinkage factor.

Typically, the distortion of the magnetic substrate 200 to be caused by the difference in shrinkage factor of the first magnetic layer 210 is maximal at a corner thereof. In the magnetic substrate 200 with this configuration, it is possible to effectively reduce the distortion to be caused by a difference in shrinkage factor at the corner.

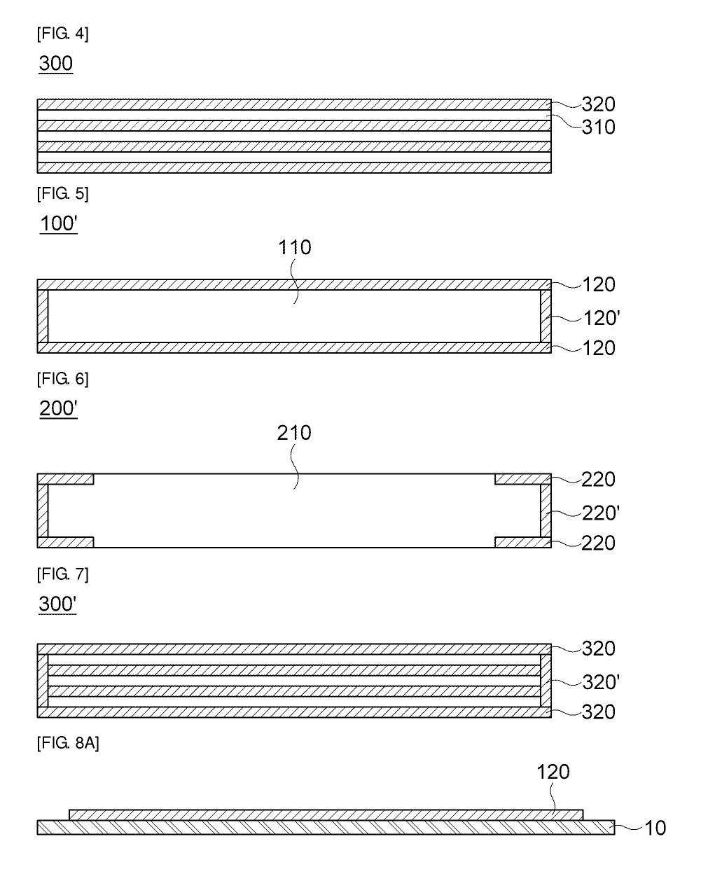

As shown in FIG. 4, a magnetic substrate 300 according to a third embodiment of the present disclosure includes a first magnetic layer 310 and at least one of second magnetic layers 320 formed within the first magnetic layer 310, unlike the magnetic substrate 100 according to the first embodiment.

The thicknesses of the first and second magnetic layers 310 and 320 may be set to fall within the range of 50 to 200 μm, respectively.

If the thicknesses of the first magnetic layer 310 and the second magnetic layer 320 are too thin, it is prone to fragile and be severely shrunk. Meanwhile, the thicknesses of the first and second magnetic layers 310 and 320 are too thick, it is difficult to control a process and a surface roughness.

On the other hand, the second magnetic layer 320 may be further formed on a side surface of the first magnetic layer 310, unlike the first to third embodiments shown in FIGS. 5 to 7.

This reduces a distortion in a horizontal direction, which is caused by the difference in shrinkage factor of the first magnetic layer 310.

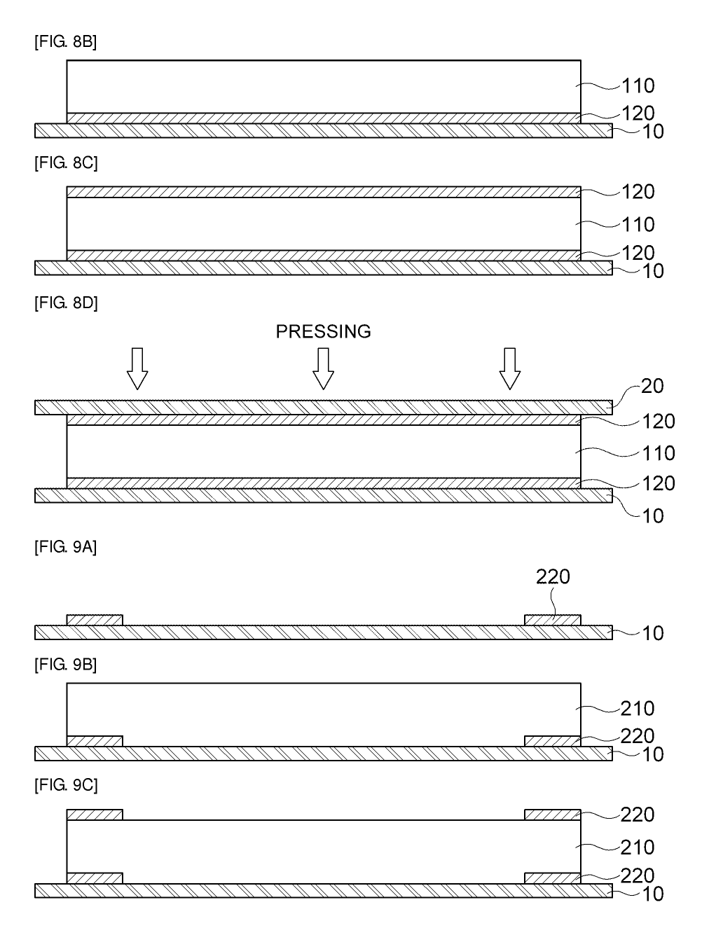

FIG. 8 shows a schematic cross-sectional view illustrating a method of manufacturing the magnetic substrate according to other embodiment of the present disclosure.

First, a second magnetic material 120a is coated on the upper surface of a base substrate 10.

Subsequently, a first magnetic material 110a is coated on the upper surface of the first magnetic material 120a.

Subsequently, the second magnetic material 120a is coated on the upper surface of the first magnetic material 110a.

Upon the completion of the processes as described above, the magnetic materials are subjected to a sintering process so that the magnetic substrate can be manufactured.

The grain size of the first magnetic material 110a is set to fall within the range of 1 to 5 μm, and the grain size of the second magnetic material 120a is set to fall within the range of 30 to 50 μm. The description on these configurations is similar to the above-mentioned description, and thus, a description thereof will be omitted to avoid duplication herein.

In other embodiment, the sintering process may be performed in synchronism with a pressing process using a press plate 20. In this case, the pressing process is preferably performed at the range of pressure of 10 to 50 MPa.

An extremely high pressure may cause a crack and a local difference in shrinkage factor, while an extremely low pressure may cause a decreased sintering density and a reduced distortion.

Preferably, the sintering process is performed at a temperature ranging from 600 to 900 degrees Celsius for 2 to 3 hours.

When the temperature exceeds a predetermined temperature (e.g., 900 degrees Celsius), a grain growth is occurred so that a deteriorated bending force and voids are caused. When the temperature is equal to or lower than a predetermined temperature (e.g., 600 degrees Celsius), it results in a poor cohesion force between powder particles, to thereby cause deterioration in a sintering density, and hence, decrease electrical properties such as a permittivity, permeability, Q value, or the like.

In addition, if the period of time exceeds the range of 2 to 3 hours, the sintering is not performed, which causes a reduced sintering density. Further, this fails to produce a crystal phase, thereby deteriorating electrical properties such as permeability, Q value or the like.

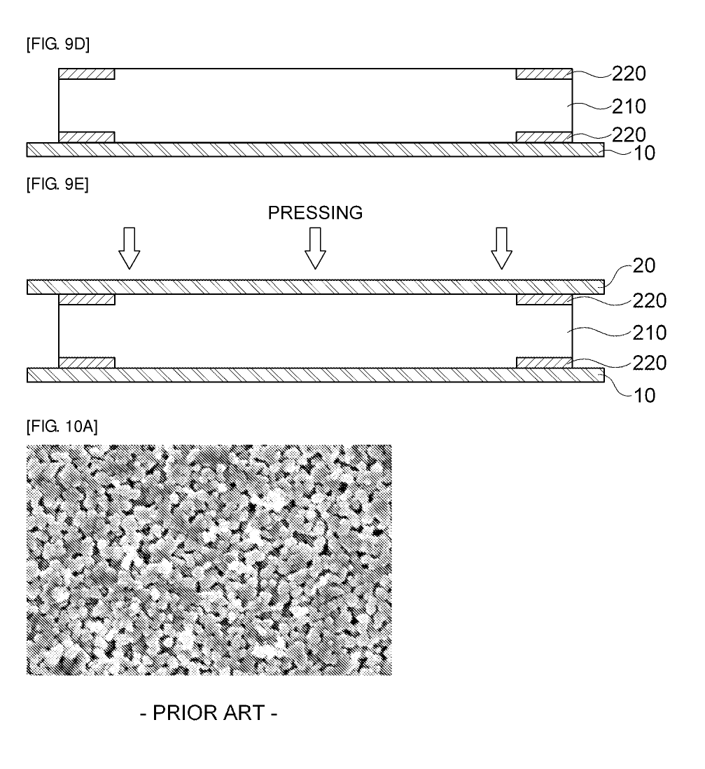

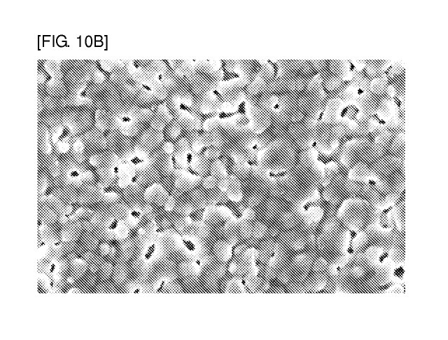

FIG. 9 shows a schematic cross-sectional view illustrating a method of manufacturing a magnetic substrate according to another embodiment of the present disclosure.

The embodiment shown in FIG. 9 is similar to the second embodiment of the magnetic substrate 200 as shown in FIG. 3.

As shown in FIG. 9, a second magnetic material 220a is initially coated on left and right regions of the upper surface of the base substrate 10.

In one embodiment, for example, a screen printing technique may be used in coating the second magnetic material 220a on the base substrate 10.

Subsequently, a first magnetic layer 210a is formed on the upper surfaces of the second magnetic material 220a and the base substrate 10, respectively.

Subsequently, the second magnetic material 220a is coated on left and right regions of the upper surface of the first magnetic layer 210a.

Through the above-mentioned sintering process, it is possible to manufacture the magnetic substrate. The description on the sintering process is similar to the above-mentioned description, and thus, a description thereof will be omitted to avoid duplication herein.

FIG. 10A is a photograph showing a fine structure of a conventional magnetic substrate, and FIG. 10B is a photograph showing a fine structure of a magnetic substrate according to one embodiment of the present disclosure.

Referring to FIGS. 10A and 10B, it is appreciated that a grain growth and a shrinkage factor of the magnetic layer have been uniformity performed on the magnetic substrate according to one embodiment of the present disclosure.

Further, upon the comparison of flatness between the magnetic substrate made of only the first magnetic layer and that according to the present disclosure, it is appreciated that the magnetic substrate according to the present disclosure is enhanced about 4 times or higher compared to that made of only the first magnetic layer.

While the invention has been described in detail with reference to preferred embodiments thereof, it will be appreciated by those skilled in the art that changes may be made in these embodiments without departing from the scope of the invention.

Thus, the scope of the invention should be determined by the appended claims and their equivalents, rather than by the described embodiments.

1. A magnetic substrate, comprising:
a first magnetic layer made of a first magnetic material; and
a second magnetic layer made of a second magnetic material,
wherein the first and second magnetic materials are equal each other, and have different grain sizes.

2. The magnetic substrate according to claim 1, wherein the grain size of the second magnetic material is set to fall within the range of 6 to 50 times that of the first magnetic material.

3. The magnetic substrate according to claim 1, wherein the grain size of the first magnetic layer is set to fall within the range of 1 to 5 μm, and the grain size of the second magnetic layer is set to fall within the range of 30 to 50 μm.

4. The magnetic substrate according to claim 1, wherein the second magnetic layer is formed on the upper and bottom surfaces of the first magnetic layer, respectively.

5. The magnetic substrate according to claim 4, wherein the thickness of the first magnetic layer is set to 2.5 to 14 times that of the second magnetic layer.

6. The magnetic substrate according to claim 4, wherein the thickness of the first magnetic layer is set to fall within the range of 500 to 700 μm, and the thickness of the second magnetic layer is set to fall within the range of 50 to 200 μm.

7. The magnetic substrate according to claim 4, wherein the second magnetic layer is further formed on a side surface of the first magnetic layer.

8. The magnetic substrate according to claim 1, wherein the second magnetic layer is formed on respective corner of the upper and bottom surfaces of the first magnetic layer

9. The magnetic substrate according to claim 8, wherein the thickness of the first magnetic layer is set to fall within the range of 2 to 7 times that of the second magnetic layer.

10. The magnetic substrate according to claim 8, wherein the thickness of the first magnetic layer is set to fall within the ranges of 400 to 700 μm, and the thickness of the second magnetic layer is set to fall within the ranges of 100 to 200 μm.

11. The magnetic substrate according to claim 8, wherein the length of the first magnetic layer is 3.2 to 6.7 times that of the second magnetic layer.

12. The magnetic substrate according to claim 8, wherein the length of the first magnetic layer is set to fall within the range of 8 to 12 mm, and the length of the second magnetic layer is set to fall within the range of 1.8 to 2.5 mm.

13. The magnetic substrate according to claim 8, wherein the thickness of the first magnetic layer is set to fall within the range of 2 to 7 times that of the second magnetic layer, and the length of the first magnetic layer is 3.2 to 6.7 times that of the second magnetic layer.

14. The magnetic substrate according to claim 8, wherein the thickness and length of the first magnetic layer are set to fall within the ranges of 400 to 700 μm, and 8 to 12 mm, respectively; and the thickness and length of the second magnetic layer are set to fall within the ranges of 100 to 200 μm, and 1.8 to 2.5 mm, respectively.

15. The magnetic substrate according to claim 8, wherein the second magnetic layer is further formed on a side surface of the first magnetic layer.

16. The magnetic substrate according to claim 1, wherein the second magnetic layer is formed on the upper and bottom surfaces of the first magnetic layer, respectively,
wherein the at least one of the second magnetic layers are formed inside of the first magnetic layer.

17. The magnetic substrate according to claim 16, wherein the thickness of the second magnetic layer is set to fall within the range of 50 to 200 μm.

18. The magnetic substrate according to claim 16, wherein the thicknesses of the first and second magnetic layers are set to fall within the range of 50 to 200 μm, respectively.

19. The magnetic substrate according to claim 16, wherein the second magnetic layer is further formed on a side surface of the first magnetic layer.

20. A method of manufacturing a magnetic substrate, the method comprising:
coating a second magnetic material on the upper surface of a base substrate;
coating a first magnetic material on the upper surface of the second magnetic material;
coating the second magnetic material on the upper surface of the first magnetic material; and
after the coating the second magnetic material, sintering the first and second magnetic materials,
wherein the first and second magnetic materials have different grain sizes.

21. The method according to claim 20, wherein the grain size of the first magnetic material is set to fall within the range of 1 to 5 μm, and the grain size of the second magnetic material is set to fall within the range of 30 to 50 μm.

22. The method according to claim 20, wherein the sintering is performed at a pressure having the range of 10 to 50 MPa.

23. The method according to claim 20, wherein the sintering is performed at a temperature having the range of 600 to 900 degrees Celsius.

24. The method according to claim 20, wherein the sintering is performed at a temperature ranging from 600 to 900 degrees Celsius for 2 to 3 hours.

25. The method according to claim 20, wherein the process is fed back to the coating a first magnetic material after the coating the second magnetic material, wherein the coating a first magnetic material and coating the second magnetic material are further performed at least one time.

26. A method of manufacturing a magnetic substrate, the method comprising:
coating a second magnetic material on left and right regions of the upper surface of a base substrate;
coating a first magnetic material on the upper surfaces of the second magnetic material and the base substrate;
coating the second magnetic material on left and right regions of the upper surface of the first magnetic material; and
after the coating the second magnetic material, sintering the first and second magnetic materials,
wherein the first and second magnetic materials have different grain sizes.
